(19) United States
(12) Patent Application Publication
(10) Pub. No.: US 2017/0139922 A1
(43) Pub. Date: May 18, 2017

(54) DATA PROCESSING SERVER AND DATA PROCESSING METHOD THEREOF

(71) Applicant: Institute For Information Industry, Taipei (TW)

(72) Inventors: Chin-Feng LAI, Tainan City (TW); Ying-Hsun LAI, Kaohsiung City (TW); Cheng-Yu HOU, Changhua City (TW); Yu-Hsiu LIN, New Taipei City (TW)

(21) Appl. No.: 14/962,912

(22) Filed: Dec. 8, 2015

(30) Foreign Application Priority Data
Nov. 18, 2015 (TW) 104138045

(51) Int. Cl. G06F 17/30

(52) U.S. Cl. CPC G06F 17/3053; G06F 17/30516; G06F 17/30554

(57) ABSTRACT

A data processing server and a data processing method thereof are provided. The data processing server includes a database, a non-real time data processing module and a real time data processing module. The database records a first data processing function. The non-real time data processing module receives data stream and analyzes the data stream according to the first data processing function for generating at least one first data weight. The real time data processing module receives the data stream and updates a real time data processing configuration according to the first data processing function and the at least one first data weight. The real time data processing module analyzes the data stream according to the real time data processing configuration for generating a real time data output.

### PRIORITY

This application claims priority to Taiwan Patent Application No. 104138045 filed on Nov. 18, 2015, which are hereby incorporated by reference in its entirety.

### FIELD

The present invention relates to a data processing server and a data processing method thereof. More particularly, the present invention relates to a data processing server and a data processing method thereof for big data.

### BACKGROUND

In conventional data processing, users can analyze data through general computers under reasonable conditions to obtain desired outputs because the volume of data being processed is relative small. However, with the development of the science and technologies, there is a tremendous growth in the volume of data used by the users via computers and networks. In this case, it is difficult for the users to efficiently obtain desired outputs in real time by the conventional data processing methods. Accordingly, data processing methods for big data have been developed and can currently be classified into batch processing and real time processing.

In particular, the batch processing, as a kind of data processing method for big data, first splits a file having a large volume of data and then processes the data in a non-real time manner, so it has the drawbacks that the output delay is too large and the computation is complicated. On the other hand, the real time processing, as another kind of data processing method for big data, directly processes a file having a large volume of data and generates an output. However, the result of the real time processing may not be accurate enough, and if the proportion of data associated with an emergency event during a short time period to the total data is too small, then it is impossible to make accurate judgment on the emergency event.

In view of the drawbacks of the aforesaid data processing methods for big data, technologies for integrating the result of the batch processing with the result of the real time processing and then outputting an integrated result to improve the accuracy have been available. However, in these technologies, the processing still has to wait for the result of the batch processing before outputting the integrated result, and the real time processing methods still need to detect and determine the data of a certain event according to the predefined logic and process, so the real-time nature of data processing is obviously insufficient.

Accordingly, an urgent need exists in the art to overcome the drawbacks of the conventional data processing for big data and meanwhile to improve the real-time nature and the accuracy of the output data.

### SUMMARY

The disclosure includes a data processing server, which comprises a database, a non-real time data processing module and a real time data processing module. The database is configured to record a first data processing function. The non-real time data processing module is configured to receive a data stream; analyze the data stream according to the first data processing function to generate at least one first data weight; and store the at least one first data weight into the database. The real time data processing module is configured to receive the data stream; retrieve the first data processing function and the at least one first data weight from the database; update a real time data processing configuration according to the first data processing function and the at least one first data weight, wherein the real time data processing configuration comprises the first data processing function and the at least one first data weight; and analyze the data stream according to the real time data processing configuration to generate a real time data output.

The disclosure also includes a data processing method for use in a data processing server. The data processing server comprises a database, a non-real time data processing module and a real time data processing module. The database is configured to record a first data processing function. The data processing method comprises the following steps of: (a) enabling the non-real time data processing module to receive a data stream; (b) enabling the non-real time data processing module to analyze the data stream according to the first data processing function to generate at least one first data weight; (c) enabling the non-real time data processing module to store the at least one first data weight into the database; (d) enabling the real time data processing module to receive the data stream; (e) enabling the real time data processing module to retrieve the first data processing function and the at least one first data weight from the database; (f) enabling the real time data processing module to update a real time data processing configuration according to the first data processing function and the at least one first data weight, wherein the real time data processing configuration comprises the first data processing function and the at least one first data weight; and (g) enabling the real time data processing module to analyze the data stream according to the real time data processing configuration to generate a real time data output.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a data processing server according to a first embodiment of the present invention;

FIG. 1B is a schematic view illustrating the data processing server processing data according to the first embodiment of the present invention;

FIG. 2A is a schematic view of a data processing server according to a second embodiment of the present invention;

FIG. 2B is a schematic view illustrating the data processing server processing data according to the second embodiment of the present invention;

FIG. 3A is a schematic view of a data processing server according to a third embodiment of the present invention;

FIG. 3B is a schematic view illustrating the data processing server processing data according to the third embodiment of the present invention;

FIG. 3C is another schematic view illustrating the data processing server processing data according to the third embodiment of the present invention;

FIG. 4A is a view illustrating that the real time data processing is performed on a data stream in the data processing server according to a fourth embodiment of the present invention;

FIG. 4B is a view illustrating that the non-real time data processing is performed on the data stream in the data processing server according to the fourth embodiment of the present invention;

FIG. 4C is another view illustrating that the real time data processing is performed on the data stream in the data processing server according to the fourth embodiment of the present invention;

FIG. 4D is another view illustrating that the non-real time data processing is performed on the data stream in the data processing server according to the fourth embodiment of the present invention;

FIG. 4E is another view illustrating that the real time data processing is performed on the data stream in the data processing server according to the fourth embodiment of the present invention;

FIG. 5 is a flowchart diagram of a data processing method according to a fifth embodiment of the present invention; and

FIG. 6 is a flowchart diagram of a data processing method according to a sixth embodiment of the present invention.

### DETAILED DESCRIPTION

In the following description, the present invention will be explained with reference to example embodiments thereof. However, these example embodiments are not intended to limit the present invention to any specific example, embodiment, environment, applications or implementations described in these example embodiments. Therefore, description of these example embodiments is only for purpose of illustration rather than to limit the present invention.

In the following embodiments and the attached drawings, elements unrelated to the present invention are omitted from depiction; and dimensional relationships among individual elements in the attached drawings are illustrated only for ease of understanding, but not to limit the actual scale.

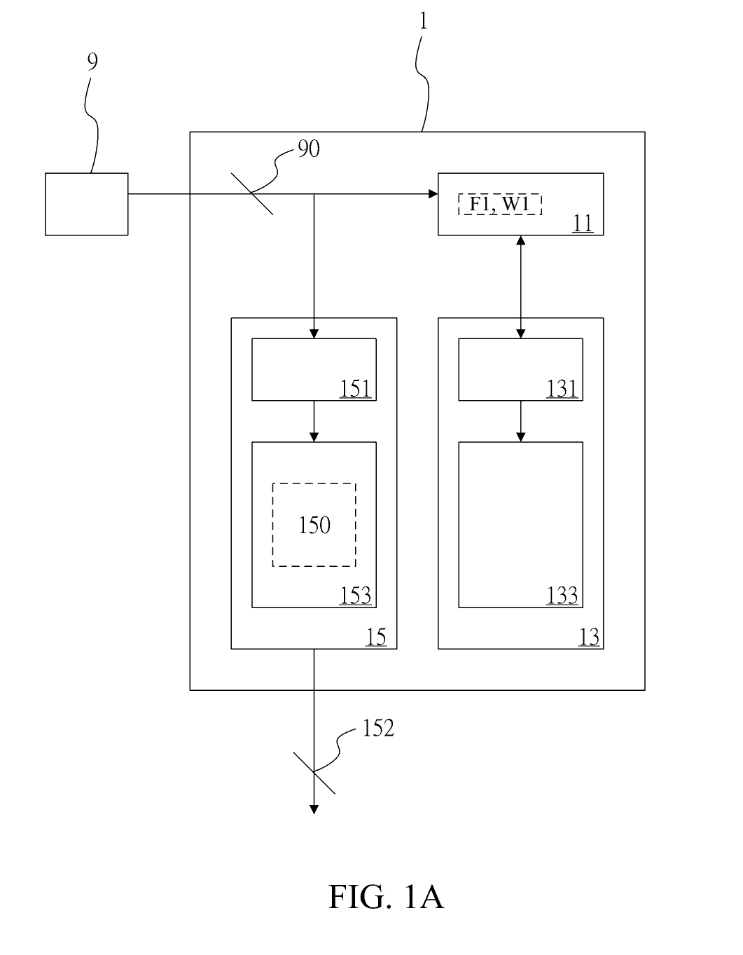

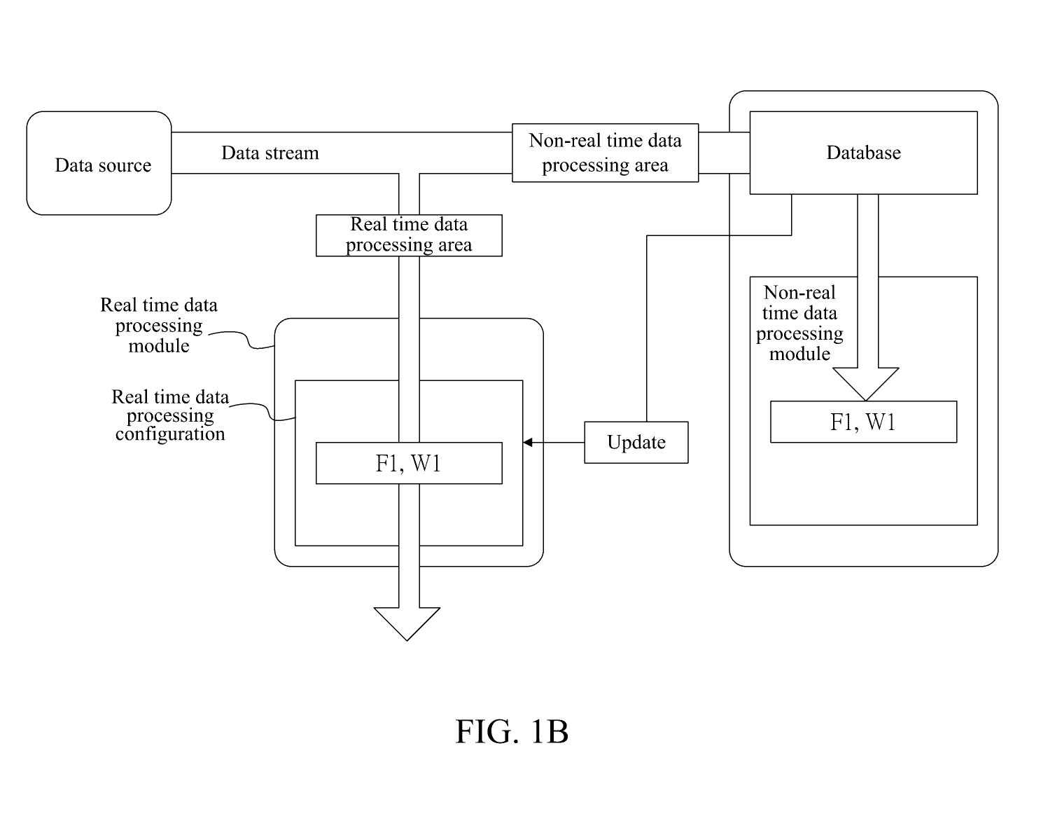

Please refer to FIG. 1A to FIG. 1B first. FIG. 1A is a schematic view of a data processing server 1 according to a first embodiment of the present invention, and FIG. 1B is a schematic view illustrating the data processing server 1 processing data according to the first embodiment of the present invention. The data processing server 1 comprises a database 11, a non-real time data processing module 13 and a real time data processing module 15. The database 11 records a first data processing function F1. The non-real time data processing module 13 comprises a non-real time data receiving unit 131 and a non-real time data analyzing unit 133. The real time data processing module 15 comprises a real time data receiving unit 151 and a real time data analyzing unit 153. Interactions between elements for processing data will be further described hereinafter.

Specifically, as shown in FIG. 1A and FIG. 1B, the data processing server 1 receives a data stream 90 from a data source 9. Then, from the perspective of the non-real time data processing module 13, the non-real time data receiving unit 131 first receives the data stream 90, and the non-real time data analyzing unit 133 analyzes the data stream 90 according to the first data processing function F1 recorded in the database 11 to generate at least one first data weight W1 related to the data stream 90. Thereafter, the non-real time data analyzing unit 133 stores the at least one first data weight W1 into the database 11.

On the other hand, from the perspective of the real time data processing module 15, the real time data processing module 15 mainly uses a real time data processing configuration 150 to process the real time data, and meanwhile the real time data processing module 15 may also determine whether any content in the database 11 is updated for use. In detail, the real time data processing module 15 uses the real time data receiving unit 151 to receive the data stream 90, and meanwhile the real time data analyzing unit 153 retrieves the first data processing function F1 and the at least one first data weight W1 updated by the non-real time data processing module 13 from the database 11.

Thereafter, the real time data analyzing unit 153 may update the real time data processing configuration 150 according to the first data processing function F1 and the at least one first data weight W1 so that the first data processing function F1 and the at least one first data weight W1 are added into the real time data processing configuration 150 for use. Finally, the real time data analyzing unit 153 uses the updated real time processing configuration 150 to analyze the data stream 90 and generate a real time data output 152. In this way, since the real time data processing configuration 150 has been updated according to the first data processing function F1 and the at least one first data weight W1, the real time data output 152, that is generated when the real time data analyzing unit 153 uses the real time processing configuration 150 to analyze the data stream 90, may also have a high reliability of the non-real time data in addition to the real-time nature thereof.

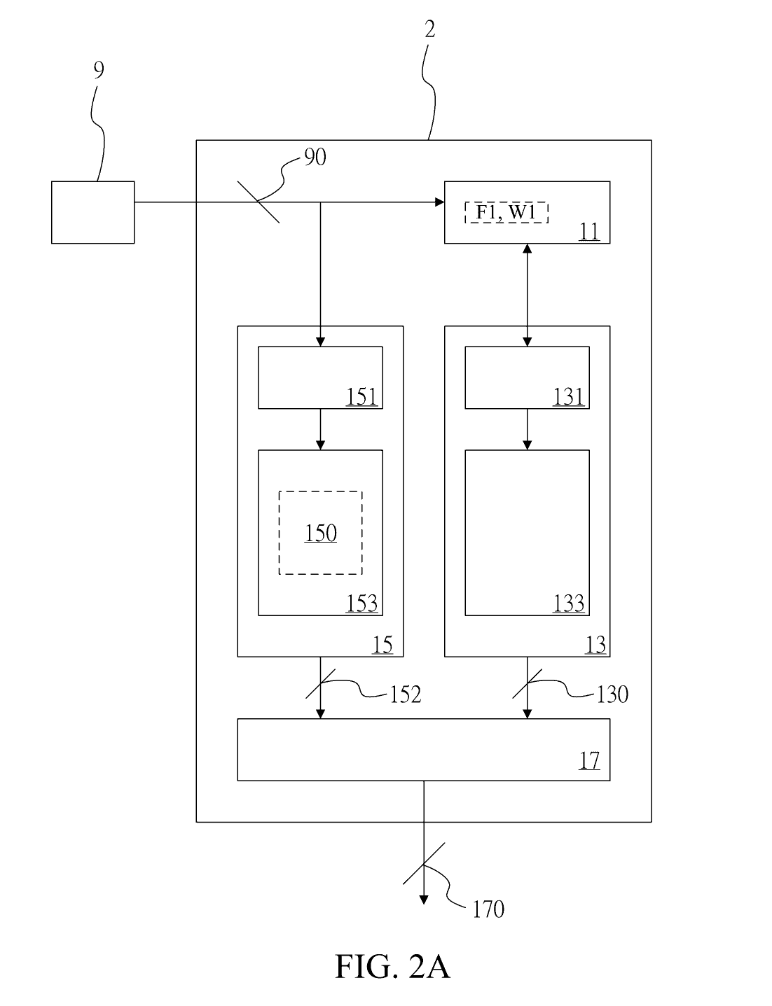

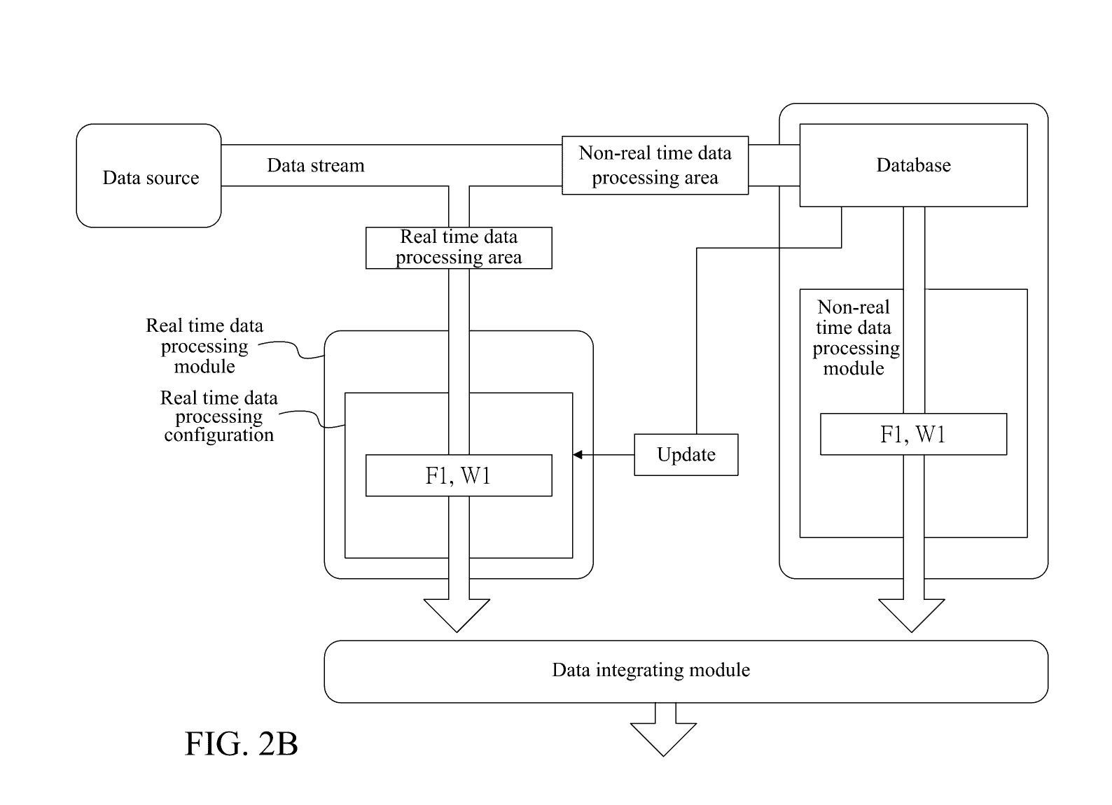

Please refer to FIG. 2A to FIG. 2B. FIG. 2A is a schematic view of a data processing server 2 according to a second embodiment of the present invention, and FIG. 2B is a schematic view illustrating the data processing server 2 processing data according to the second embodiment of the present invention. The architecture of the second embodiment is similar to that of the first embodiment, and thus the elements labeled by same reference numerals have the same functions and will not be further described herein. The second embodiment mainly describes the process of integrating data by using a data integrating module 17.

Similarly, as shown in FIG. 2A to FIG. 2B, the data processing server 2 receives the data stream 90 from the data source 9. Then, from the perspective of the non-real time data processing module 13, the non-real time data receiving unit 131 first receives the data stream 90, and the non-real time data analyzing unit 133 analyzes the data stream 90 according to the first data processing function F1 recorded in the database 11 to generate at least one first data weight W1 related to the data stream 90. Thereafter, the non-real time data analyzing unit 133 analyzes the data stream 90 according to the first data processing function F1 and the at least one first data weight W1 to generate a non-real time data output 130, and meanwhile stores the at least one first data weight W1 into the database 11.

On the other hand, from the perspective of the real time data processing module 15, the real time data processing module 15 mainly uses the real time data processing configuration 150 to process the real time data, and meanwhile the real time data processing module 15 may also determine whether any content in the database 11 is updated for use. In detail, the real time data processing module 15 uses the real time data receiving unit 151 to receive the data stream 90, and meanwhile the real time data analyzing unit 153 retrieves the first data processing function F1 and the at least one first data weight W1 updated by the non-real time data processing module 13 from the database 11.

Thereafter, the real time data analyzing unit 153 may update the real time data processing configuration 150 according to the first data processing function F1 and the at least one first data weight W1 so that the first data processing function F1 and the at least one first data weight W1 are added into the real time data processing configuration 150 for use. The real time data analyzing unit 153 uses the updated real time processing configuration 150 to analyze the data stream 90 and generate the real time data output 152.

It shall be particularly appreciated that, in the second embodiment, both the non-real time data output 130 and the real time data output 152 are output into the data integrating module 17. In other words, the data integrating module 17 retrieves the non-real time data output 130 and the real time data output 152 and accordingly decides an integrated data output 170. In this way, the user not only can inquire the non-real time data output 130 and the real time data output 152 respectively, but can also inquire the integrated data.

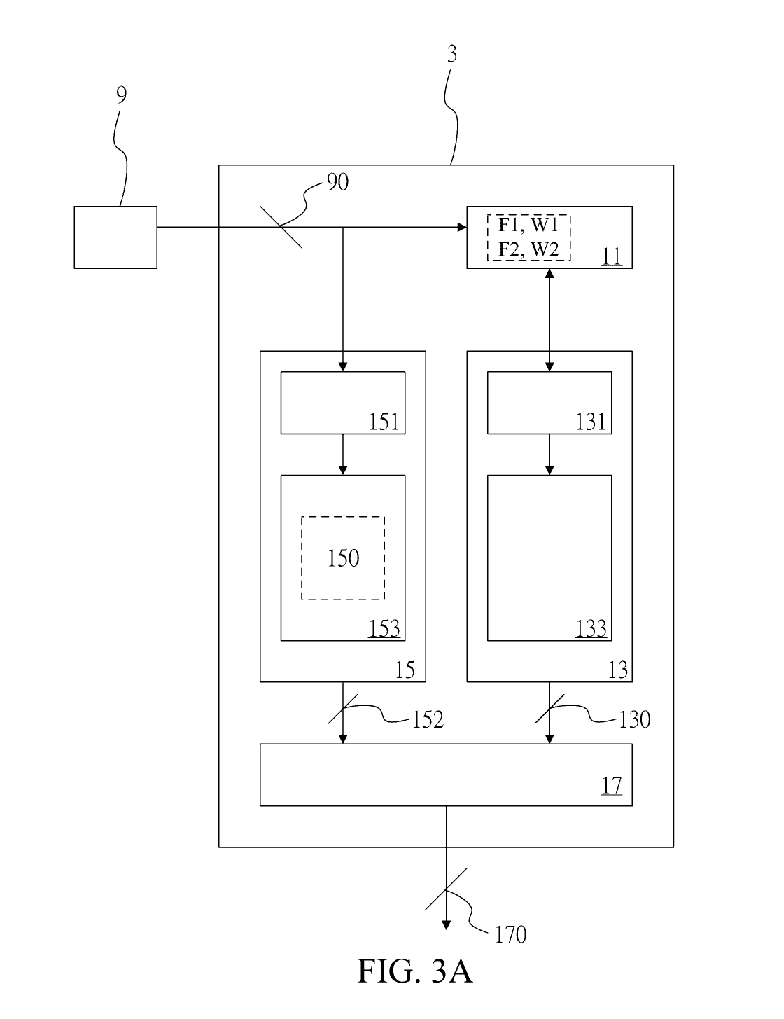

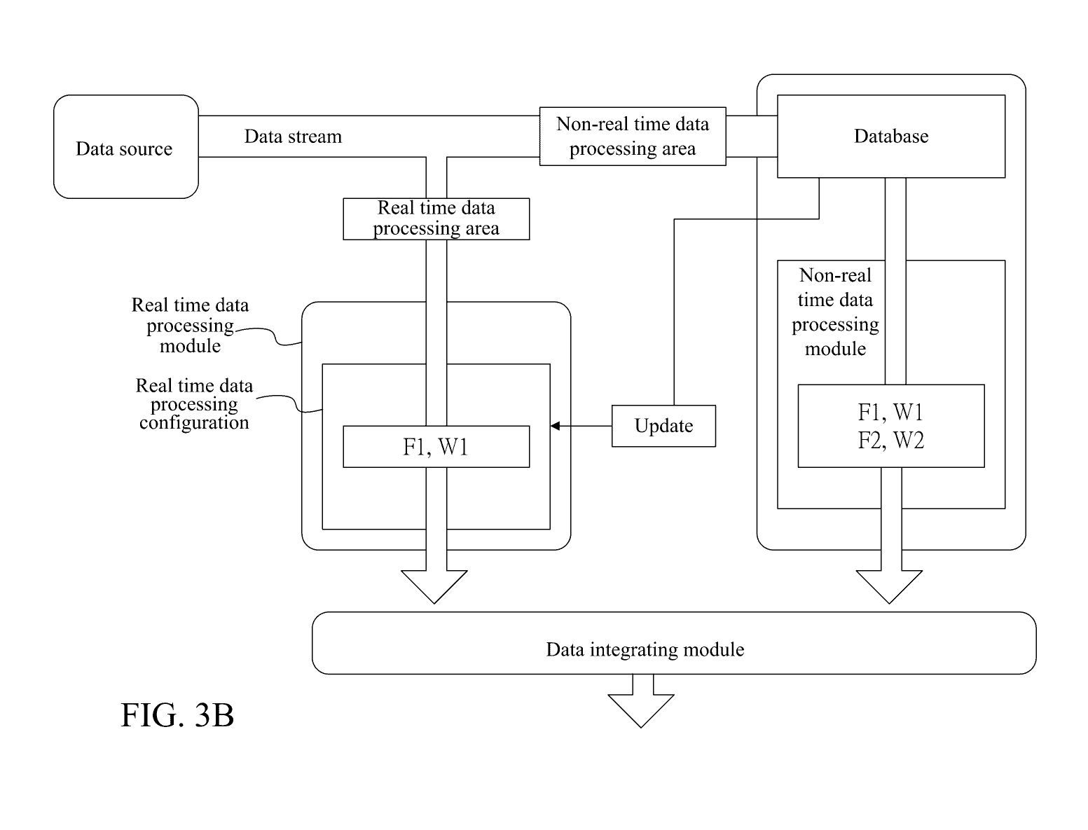

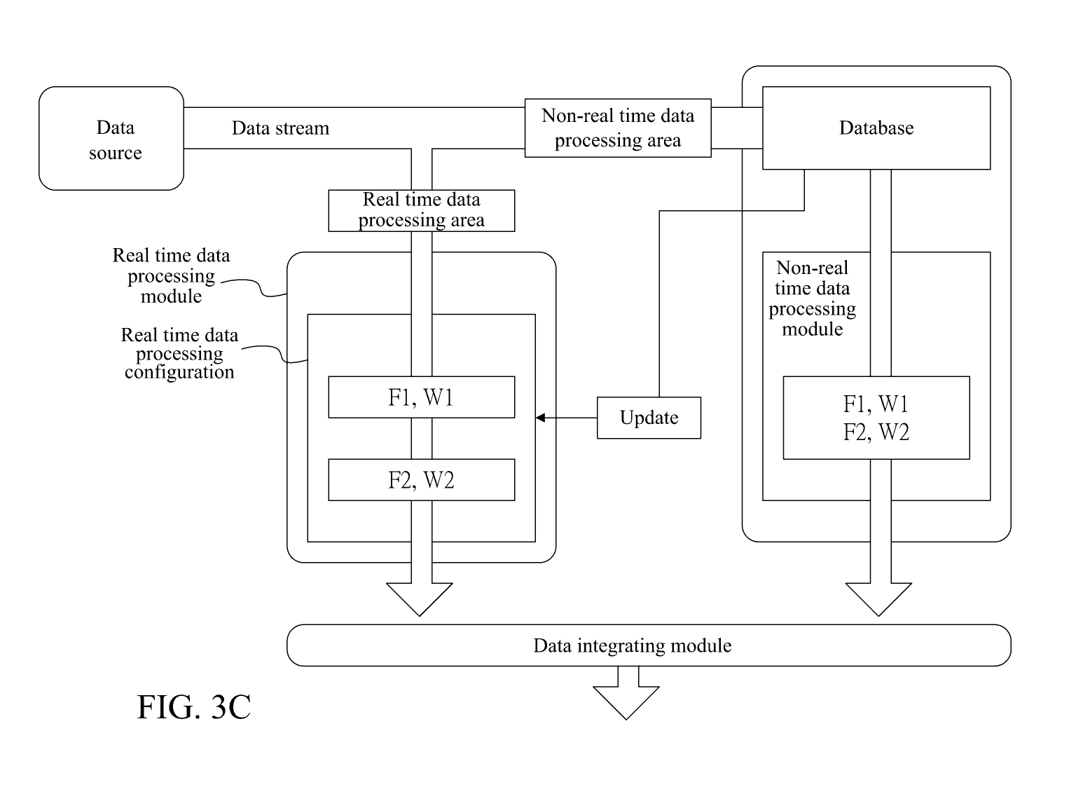

Please refer to FIG. 3A first, which is a schematic view of a data processing server 3 according to a third embodiment of the present invention. The architecture of the third embodiment is similar to that of the aforesaid embodiments, and thus the elements labeled by same reference numerals have the same functions and will not be further described herein. The database 11 of the third embodiment further records a second data processing function F2, and the third embodiment mainly describes the application of multiple data processing functions in more detail.

Specifically, as shown in FIG. 3A, the data processing server 3 receives the data stream 90 from a data source 9. Then, from the perspective of the non-real time data processing module 13, the non-real time data receiving unit 131 first receives the data stream 90, and the non-real time data analyzing unit 133 analyzes the data stream 90 according to the first data processing function F1 recorded in the database 11 to generate at least one first data weight W1 related to the data stream 90. Meanwhile, in the third embodiment, the non-real time data analyzing unit 133 also analyzes the data stream 90 according to the second data processing function F2 recorded in the database 11 to generate at least one second data weight W2 related to the data stream 90. Thereafter, the non-real time data analyzing unit 133 stores the at least one first data weight W1 and the at least one second data weight W2 into the database 11.

On the other hand, from the perspective of the real time data processing module 15, the real time data processing module 15 mainly uses the real time data processing configuration 150 to process the real time data, and meanwhile the real time data processing module 15 may also determine whether any content in the database 11 is updated for use. In detail, the real time data processing module 15 uses the real time data receiving unit 151 to receive the data stream 90, and meanwhile the real time data analyzing unit 153 retrieves the related function and the data weight thereof from the database 11.

Please refer to FIG. 3B, which is a schematic view illustrating the data processing server 3 processing data according to the third embodiment of the present invention. Further speaking, if the first data function F1 and the at least one first data weight W1 are highly related to the data to be output, and the second data function F2 and the at least one second data weight W2 are less related to the data to be output, then the real time data analyzing unit 153 only retrieves the first data processing function F1 and the at least one first data weight W1 updated by the non-real time data processing module 13 from the database 11.

Thereafter, similarly, the real time data analyzing unit 153 may update the real time data processing configuration 150 according to the first data processing function F1 and the at least one first data weight W1 so that the first data processing function F1 and the at least one first data weight W1 are added into the real time data processing configuration 150 for use. Finally, the real time data analyzing unit 153 uses the updated real time processing configuration 150 to analyze the data stream 90 and generate a real time data output 152.

Please refer to FIG. 3C, which is another schematic view illustrating the data processing server 3 processing data according to the third embodiment of the present invention. In more detail, if the first data function F1, the second data function F2, the at least one first data weight W1 and the at least one second data weight W2 are all highly related to the data to be output, then the real time data analyzing unit 153 retrieves the first data function F1, the second data function F2, the at least one first data weight W1 and the at least one second data weight W2 updated by the non-real time data processing module 13 from the database 11.

Thereafter, the real time data analyzing unit 153 may update the real time data processing configuration 150 according to the first data function F1, the second data function F2, the at least one first data weight W1 and the at least one second data weight W2 so that the first data function F1, the second data function F2, the at least one first data weight W1 and the at least one second data weight W2 are added into the real time data processing configuration 150 for use. Finally, the real time data analyzing unit 153 uses the updated real time processing configuration 150 to analyze the data stream 90 and generate the real time data output 152.

It shall be particularly appreciated that, as shown in FIG. 3C, the data processing server 3 of the third embodiment may also have the data integrating module 17 which is also configured to retrieve the non-real time data output 130 and the real time data output 152 and accordingly decide the integrated data output 170. The operation of the data integrating module 17 of the third embodiment is the same as that of the aforesaid embodiment, and thus will not be further described herein.

It shall be further emphasized that, because the data format of the data stream 90 may be a data form with various different fields, the at least one first data weight W1 mainly corresponds to at least one first data field (not shown) of the data stream 90 and the at least one second data weight W2 mainly corresponds to at least one second data field (not shown) of the data stream 90 in the aforesaid embodiments, and this will be further described with exemplary examples hereinafter.

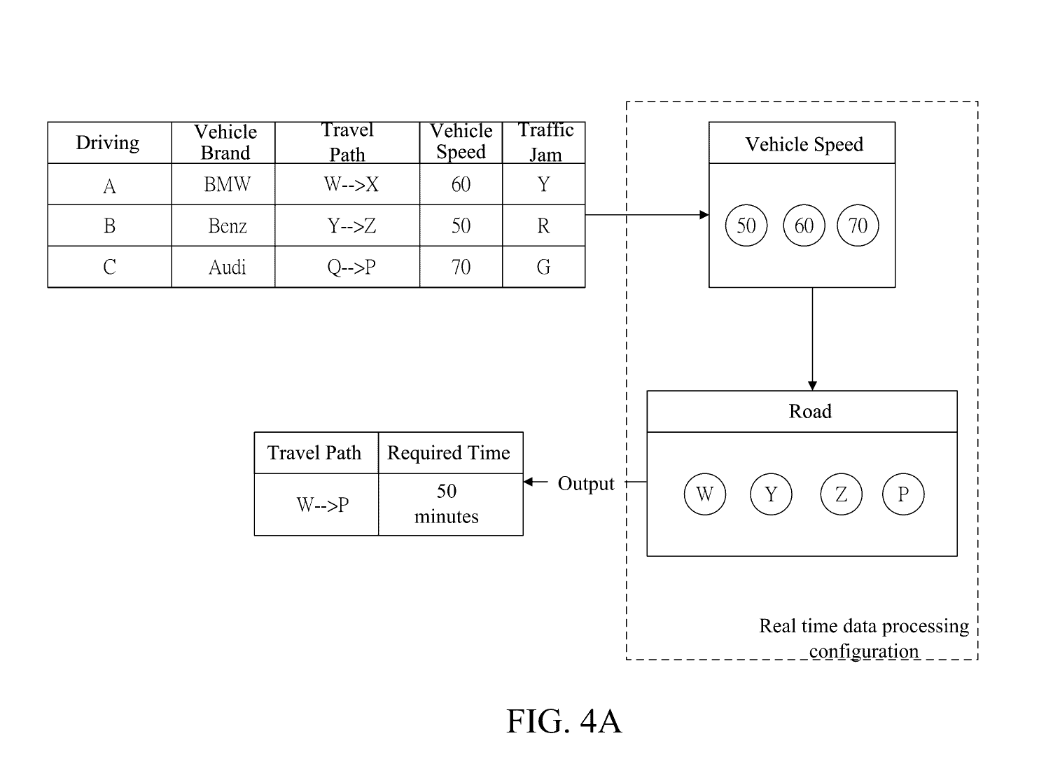

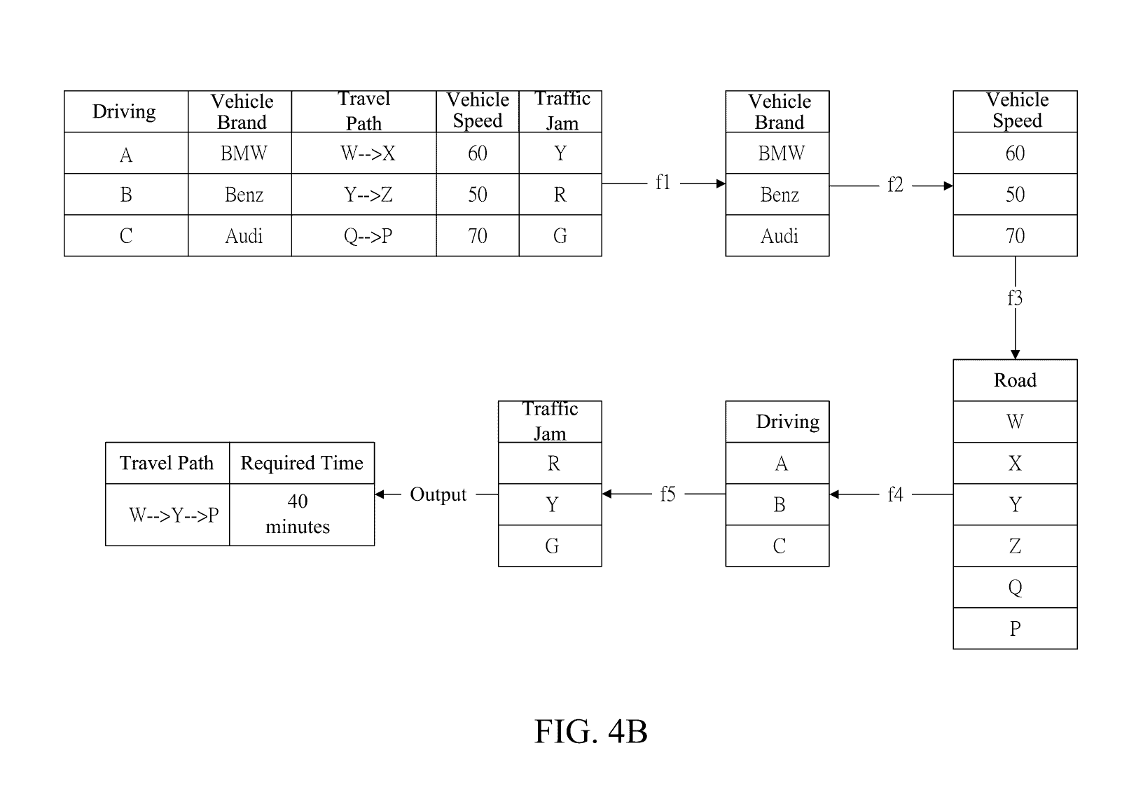

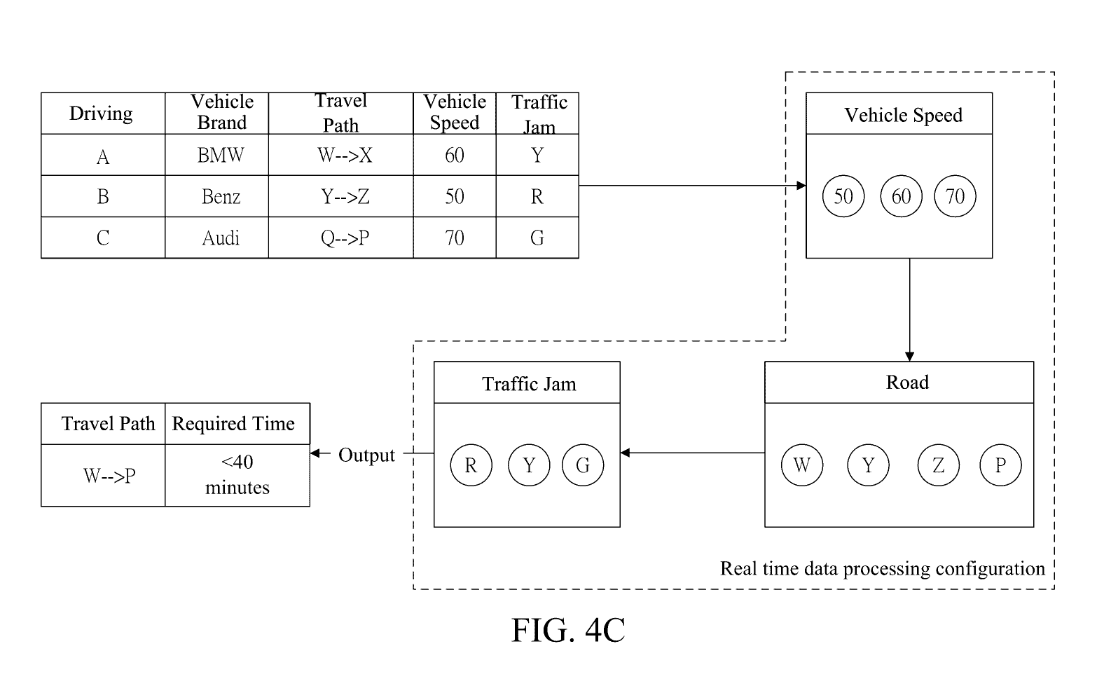

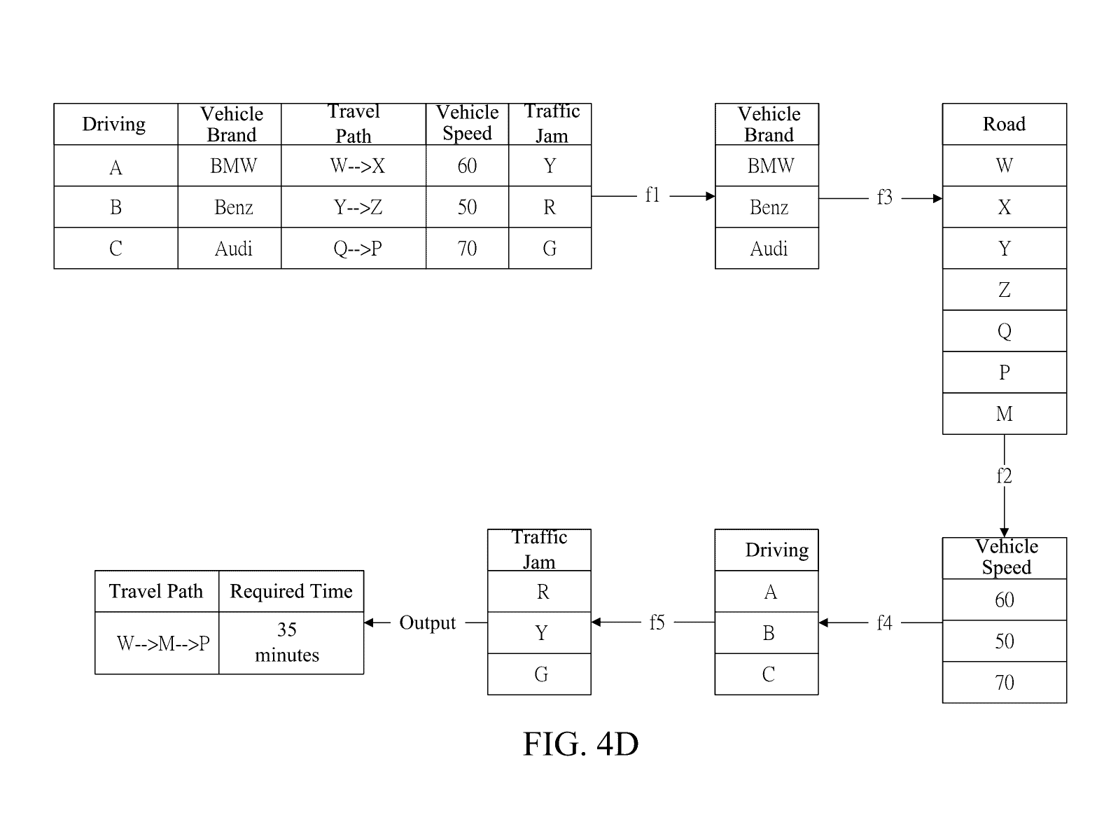

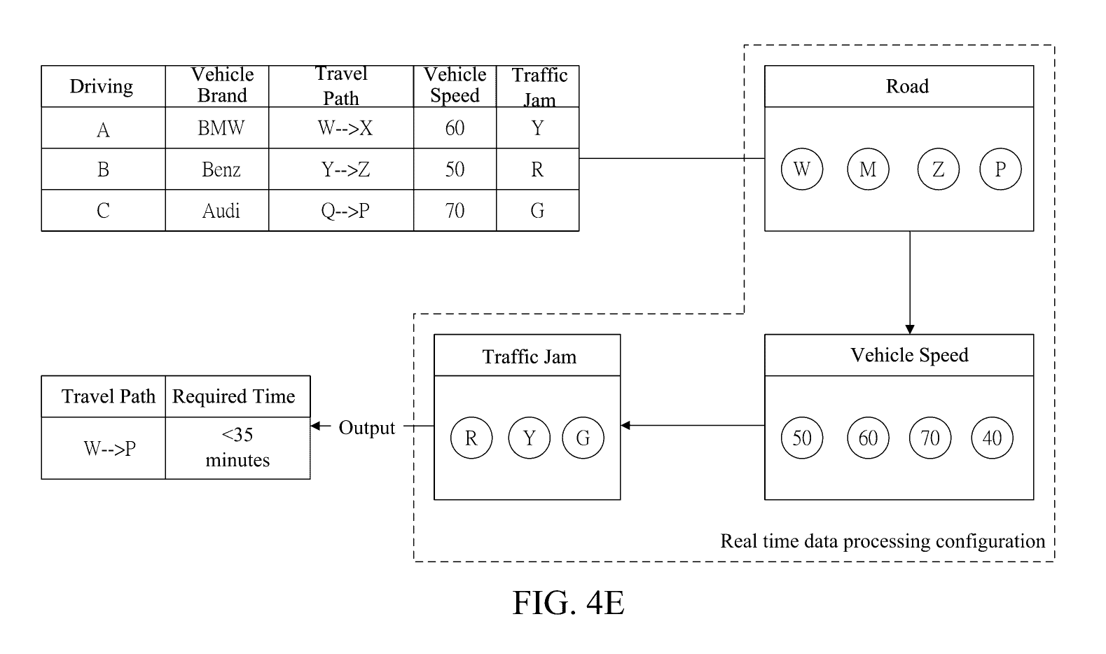

For example, please refer to FIG. 4A, which is a view illustrating that the real time data processing is performed on the data stream in the data processing server according to a fourth embodiment of the present invention. As shown in FIG. 4A, the data stream mainly comprises fields such as Driving, Vehicle Brand, Travel Path, Vehicle Speed and Traffic Jam, and in this case, the real time data processing module of the data processing server mainly processes the data stream according to the data processing configuration (e.g., the real time data processing configuration of the aforesaid embodiments) of the vehicle speed and the road. Then, when the user wants to obtain the time required by the path W->P via the data processing server, the real time data processing module mainly analyzes the vehicle speed and the road of the data stream and further determines that the path W->P needs a time output of 50 minutes.

On the other hand, since the database of the data processing server has other functions capable of processing the data stream (e.g., the first data processing function and the second data processing function of the aforesaid embodiments) stored therein, the non-real time data processing module may determine the weight value of corresponding field of data through the related function so that the real time data processing module can adjust the data processing configuration accordingly.

Please refer to FIG. 4B together, which is a view illustrating that the non-real time data processing is performed on the data stream in the data processing server according to the fourth embodiment of the present invention. In detail, after receiving the data stream, the non-real time data processing module may mainly analyze the data stream according to various functions (e.g., the Vehicle Brand, the Vehicle Speed, the Road, the Driving and the Traffic Jam) stored in the database and generate corresponding weight values for the different functions.

As shown in FIG. 4B, when the data stream passes through the Vehicle Brand Function f1, weight values BMW, Benz and Audi may be obtained. When the data stream passes through the Vehicle Speed Function f2, weight values 60, 50 and 70 may be obtained. When the data stream passes through the Road Function f3, weight values W, X, Y, Z, Q and P may be obtained. When the data stream passes through the Driving Function f4, weight values A, B and C may be obtained. When the data stream passes through the Traffic Jam Function f5, weight values Red (R), Yellow (Y) and Green (G) may be obtained. Red means a heavy traffic jam, Yellow means a general traffic jam, and Green means no traffic jam. Thereafter, the non-real time data processing module can accordingly determine that the path W->P needs a time output of 40 minutes.

Next, the non-real time data processing module stores the aforesaid functions and the weight values into the database. In this way, the real time data processing module can further use the updated functions and weight values in the database. Please refer to FIG. 4C together, which is another view illustrating that the real time data processing is performed on the data stream in the data processing server according to the fourth embodiment of the present invention.

Specifically, the real time data processing module may further determine the required function and accordingly update the real time data processing configuration. Further speaking, as shown in FIG. 4C, because the real time data processing module determines that the traffic jam is one of the main factors affecting the driving time according to the Traffic Jam Function and the weight values thereof, the real time data processing module adds the Traffic Jam Function and the weight values thereof into the real time data processing configuration.

In this way, since the real time data processing module has updated the real time data processing configuration via the functions and the weight values stored into the database by the non-real time data processing module and has added the Traffic Jam Function and the weight values thereof that directly affect the driving time, a more accurate time output of less than 40 minutes required by the path W->P may be obtained in real time when the real time data processing module further processes the data stream.

It should be noted that the order of the functions is not fixed. The non-real time data processing module and the real time data processing module are capable of optimizing the data via different orders of the functions. Please refer to FIG. 4D together, which is another view illustrating that the non-real time data processing is performed on the data stream in the data processing server according to the fourth embodiment of the present invention.

Specifically, after receiving the data stream, the non-real time data processing module may mainly analyze the data stream according to various functions (e.g., the Vehicle Brand, the Vehicle Speed, the Road, the Driving and the Traffic Jam), which are stored in the database, via different orders of the functions, and generate corresponding weight values for the different functions.

As shown in FIG. 4D, when the data stream passes through the Vehicle Brand Function f1, weight values BMW, Benz and Audi may be obtained. Then, in another data stream processing procedure, the Road Function f3 is arranged before the Vehicle Speed Function f2. Therefore, when the data stream passes through the Road Function f3 first, different weight values W, X, Y, Z, Q, P and M may be obtained since the priority of the determination of road is prior than the priority of the determination of vehicle speed.

It should be specified that, comparing with the previous example, weight value M is added in the result of the Road Function f3. In details, weight value M represents the road with 40 speed limit. Therefore, in the previous example, since the data stream passes through the Vehicle Speed Function f2 before the Road Function f3 and the determinations of the weight values of the vehicle speed are all greater than 50 (i.e., 50, 60 70), the roads with the speed limit under 50 (e.g., the road with the weight value M which has 40 speed limit) will not be generated after the data stream passes through the Road Function f3.

Accordingly, in the present example, weight values 60, 50, 70 and 40 may be obtained when the data stream passes through the Vehicle Speed Function f2. Afterwards, similarly, when the data stream passes through the Driving Function f4, weight values A, B and C may be obtained. When the data stream passes through the Traffic Jam Function f5, weight values Red, Yellow and Green may be obtained. Red means a heavy traffic jam, Yellow means a general traffic jam, and Green means no traffic jam. Thereafter, the non-real time data processing module can accordingly determine that the path W->P needs a time output of 35 minutes.

Next, the non-real time data processing module stores the aforesaid functions and the weight values into the database. In this way, the real time data processing module can further use the updated functions and weight values in the database. Please refer to FIG. 4E together, which is another view illustrating that the real time data processing is performed on the data stream in the data processing server according to the fourth embodiment of the present invention.

Similarly, the real time data processing module may further determine the required function and accordingly update the real time data processing configuration. Further speaking, as shown in FIG. 4E, because the real time data processing module determines that the traffic jam is one of the main factors affecting the driving time according to the Traffic Jam Function and the weight values thereof, the real time data processing module adds the Traffic Jam Function and the weight values thereof into the real time data processing configuration. At the same time, the order of functions in the real time data processing configuration is adjusted since the output is more optimal when the priority of the Road function is prior than the priority of the vehicle speed function.

In this way, since the real time data processing module has updated the real time data processing configuration via the functions and the weight values stored into the database by the non-real time data processing module, and has: (1) adjusted the function relation; (2) added the Traffic Jam Function and the weight values thereof that directly affect the driving time, a more accurate time output of less than 35 minutes required by the path W->P may be obtained in real time when the real time data processing module further processes the data stream.

It shall be particularly appreciated that, the aforesaid data processing server is mainly configured to process the big data; however, this is not intended to limit the implementation of the present invention. Additionally, the emphasis of the technology of the present invention is mainly on the following: the real time data processing module updates the real time data processing configuration by using the feedback of the non-real time data processing module so that the real time data processing module can obtain more accurate output through the updated real time data processing configuration. The related data processing methods and the use of the functions shall be readily appreciated by those skilled in the art based on the above description, and thus will not be further described herein.

Moreover, the data processing module of the aforesaid embodiments (e.g., the data receiving unit and the data analyzing unit of the non-real time data processing module and the real time data processing module, and the data integrating module) may be electrically constituted by hardware circuit such as a related input and output (I/O) interface and a processor. The architecture of the aforesaid data processing module shall be readily appreciated by those skilled in the art from the above description; however, this is not intended to limit the implementation of the present invention.

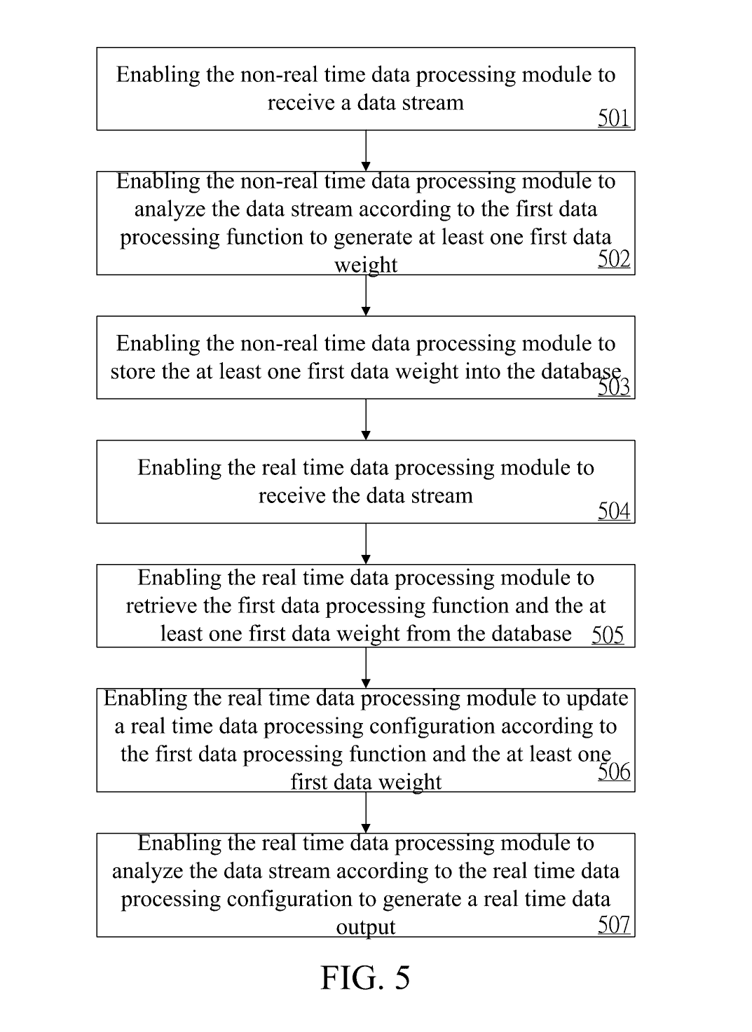

A fifth embodiment of the present invention is a data processing method, a flowchart diagram of which is shown in FIG. 5. The method of the fifth embodiment is for use in a data processing server (e.g., the data processing server of the aforesaid embodiments), and the data processing server comprises a database, a non-real time data processing module and a real time data processing module. The database is configured to record a first data processing function. Detailed steps of the fifth embodiment are as follows.

First, from the perspective of the non-real time data processing module, step 501 is executed to enable the non-real time data processing module to receive a data stream. Next, step 502 is executed to enable the non-real time data processing module to analyze the data stream according to the first data processing function to generate at least one first data weight. Step 503 is executed to enable the non-real time data processing module to store the at least one first data weight into the database.

On the other hand, from the perspective of the real time data processing module, step 504 is executed to enable the real time data processing module to receive the data stream. Step 505 is executed to enable the real time data processing module to retrieve the first data processing function and the at least one first data weight from the database.

Step 506 is executed to enable the real time data processing module to update a real time data processing configuration according to the first data processing function and the at least one first data weight. The real time data processing configuration comprises the first data processing function and the at least one first data weight. Finally, step 507 is executed to enable the real time data processing module to analyze the data stream according to the real time data processing configuration to generate a real time data output.

It shall be particularly appreciated that, in other implementations of the fifth embodiment, the data processing server may further comprise a data integrating module, and the non-real time data processing module may analyze the data stream according to the first data processing function and the at least one first data weight to generate a non-real time data output after the step 502. In this way, the data integrating module can retrieve the real time data output and the non-real time data output and accordingly decide an integrated data output after the step 507.

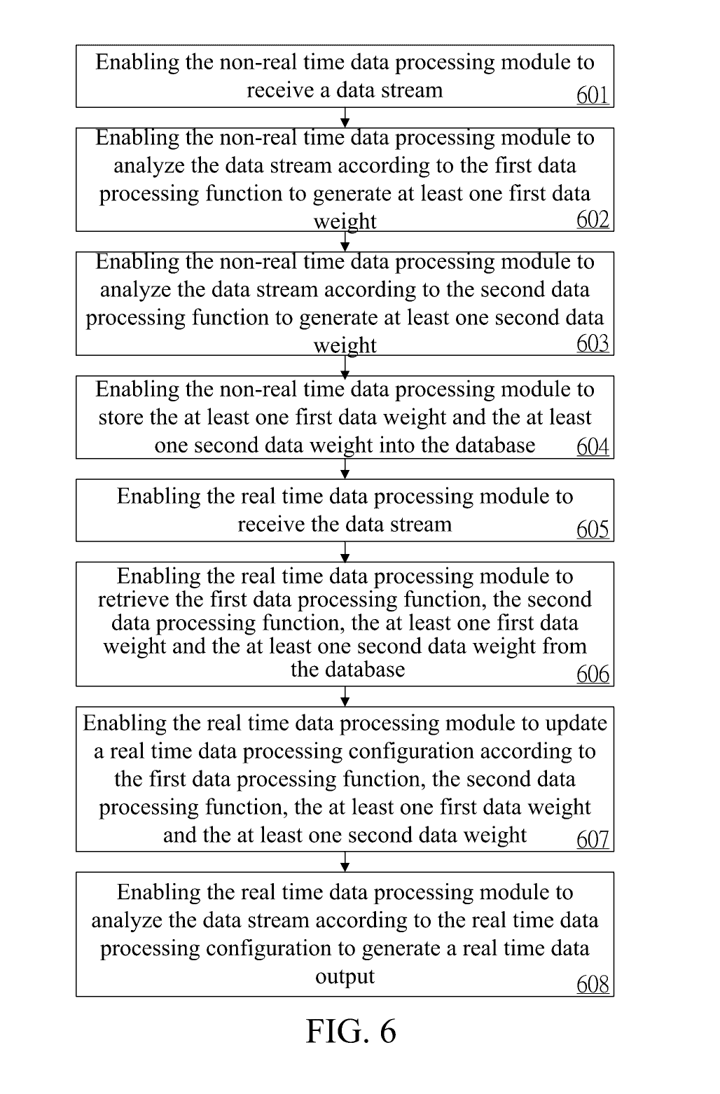

A sixth embodiment of the present invention is a data processing method, a flowchart diagram of which is shown in FIG. 6. The method of the sixth embodiment is for use in a data processing server (e.g., the data processing server of the aforesaid embodiments), and the data processing server comprises a database, a non-real time data processing module and a real time data processing module. The database is configured to record a first data processing function and a second data processing function. Detailed steps of the sixth embodiment are as follows.

First, from the perspective of the non-real time data processing module, step 601 is executed to enable the non-real time data processing module to receive a data stream. Next, step 602 is executed to enable the non-real time data processing module to analyze the data stream according to the first data processing function to generate at least one first data weight. Step 603 is executed to enable the non-real time data processing module to analyze the data stream according to the second data processing function to generate at least one second data weight. Step 604 is executed to enable the non-real time data processing module to store the at least one first data weight and the at least one second data weight into the database.

On the other hand, from the perspective of the real time data processing module, step 605 is executed to enable the real time data processing module to receive the data stream. Step 606 is executed to enable the real time data processing module to retrieve the first data processing function, the second data processing function, the at least one first data weight and the at least one second data weight from the database.

Step 607 is executed to enable the real time data processing module to update a real time data processing configuration according to the first data processing function, the second data processing function, the at least one first data weight and the at least one second data weight. The real time data processing configuration at least comprises the first data processing function, the second data processing function, the at least one first data weight and the at least one second data weight. Finally, step 608 is executed to enable the real time data processing module to analyze the data stream according to the real time data processing configuration to generate a real time data output.

Similarly, it shall be particularly appreciated that, in other implementations of the sixth embodiment, the data processing server may further comprise a data integrating module, and the non-real time data processing module may analyze the data stream according to the first data processing function, the second data processing function, the at least one first data weight and the at least one second data weight to generate a non-real time data output after the step 603. In this way, the data integrating module can retrieve the real time data output and the non-real time data output and accordingly decide an integrated data output after the step 608.

According to the above descriptions, in the data processing server and the data processing method thereof according to the present invention, the real time data processing module updates the real time data processing configuration by using the feedback of the non-real time data processing module so that the real time data processing module can obtain more accurate output through the updated real time data processing configuration. Thus, the accuracy of the output data can be improved, and meanwhile the real-time nature of the output data can be maintained.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data processing server, comprising:
a database, being configured to record a first data processing function;
a non-real time data processing module, comprising:
a non-real time data receiving unit, being configured to receive a data stream; and
a non-real time data analyzing unit, being configured to:
analyze the data stream according to the first data processing function to generate at least one first data weight; and
store the at least one first data weight into the database;
a real time data processing module, comprising:
a real time data receiving unit, being configured to receive the data stream; and
a real time data analyzing unit, being configured to:
retrieve the first data processing function and the at least one first data weight from the database;
update a real time data processing configuration according to the first data processing function and the at least one first data weight, wherein the real time data processing configuration comprises the first data processing function and the at least one first data weight; and
analyze the data stream according to the real time data processing configuration to generate a real time data output.

2. The data processing server of claim 1, further comprising a data integrating module, wherein the non-real time data analyzing unit is further configured to:
analyze the data stream according to the first data processing function and the at least one first data weight to generate a non-real time data output;
wherein the data integrating module is configured to:
retrieve the real time data output and the non-real time data output; and
decide an integrated data output according to the real time data output and the non-real time data output.

3. The data processing server of claim 1, wherein the database is further configured to record a second data processing function, and the non-real time data analyzing unit is further configured to:
analyze the data stream according to the second data processing function to generate at least one second data weight; and
store the at least one second data weight into the database.

4. The data processing server of claim 3, further comprising a data integrating module, wherein the non-real time data analyzing unit is further configured to:
analyze the data stream according to the first data processing function, the second data processing function, the at least one first data weight and the at least one second data weight to generate a non-real time data output;
wherein the data integrating module is configured to:
retrieve the real time data output and the non-real time data output; and
decide an integrated data output according to the real time data output and the non-real time data output.

5. The data processing server of claim 3, wherein the real time data analyzing unit is further configured to:
retrieve the second data processing function and the at least one second data weight from the database;
update the real time data processing configuration according to the first data processing function, the second data processing function, the at least one first data weight and the at least one second data weight, wherein the real time data processing configuration comprises the first data processing function, the second data processing function, the at least one first data weight and the at least one second data weight; and
analyze the data stream according to the real time data processing configuration to generate the real time data output.

6. The data processing server of claim 5, further comprising a data integrating module, wherein the non-real time data analyzing unit is further configured to:
analyze the data stream according to the first data processing function, the second data processing function, the at least one first data weight and the at least one second data weight to generate a non-real time data output;
wherein the data integrating module is configured to:
retrieve the real time data output and the non-real time data output; and
decide an integrated data output according to the real time data output and the non-real time data output.

7. The data processing server of claim 1, wherein the at least one first data weight corresponds to at least one first data field of the data stream.

8. The data processing server of claim 3, wherein the at least one first data weight corresponds to at least one first data field of the data stream, and the at least one second data weight corresponds to at least one second data field of the data stream.

9. A data processing method for use in a data processing server, the data processing server comprising a database, a non-real time data processing module and a real time data processing module, the database being configured to record a first data processing function, the data processing method comprising:
(a) the non-real time data processing module receiving a data stream;
(b) the non-real time data processing module analyzing the data stream according to the first data processing function to generate at least one first data weight;
(c) the non-real time data processing module storing the at least one first data weight into the database;
(d) the real time data processing module receiving the data stream;
(e) the real time data processing module retrieving the first data processing function and the at least one first data weight from the database;
(f) the real time data processing module updating a real time data processing configuration according to the first data processing function and the at least one first data weight, wherein the real time data processing configuration comprises the first data processing function and the at least one first data weight; and
(g) the real time data processing module analyzing the data stream according to the real time data processing configuration to generate a real time data output.

10. The data processing method of claim 9, wherein the data processing server further comprises a data integrating module, and the data processing method further comprises the following after the step (b):
(b1) the non-real time data processing module analyzing the data stream according to the first data processing function and the at least one first data weight to generate a non-real time data output;
wherein the data processing method further comprises the following after the step (g):
(h) the data integrating module retrieving the real time data output and the non-real time data output; and
(i) enabling the data integrating module deciding an integrated data output according to the real time data output and the non-real time data output.

11. The data processing method of claim 9, wherein the database is further configured to record a second data processing function, and the data processing method further comprises the following after the step (b):
(b1) the non-real time data processing module analyzing the data stream according to the second data processing function and generating at least one second data weight; and
wherein the step (c) further comprises:
(c1) the non-real time data processing module storing the at least one first data weight and the at least one second data weight into the database.

12. The data processing method of claim 11, wherein the data processing server further comprises a data integrating module, and the data processing method further comprises the following after the step (b1):
(b2) the non-real time data processing module analyzing the data stream according to the first data processing function, the second data processing function, the at least one first data weight and the at least one second data weight to generate a non-real time data output;
wherein the data processing method further comprises the following after the step (g):
(h) the data integrating module retrieving the real time data output and the non-real time data output; and
(i) the data integrating module deciding an integrated data output according to the real time data output and the non-real time data output.

13. The data processing method of claim 11, wherein the step (e) further comprises:
(e1) the real time data processing module retrieving the first data processing function, the second data processing function, the at least one first data weight and the at least one second data weight from the database;
wherein the step (f) further comprises:
(f1) the real time data processing module updating the real time data processing configuration according to the first data processing function, the second data processing function, the at least one first data weight and the at least one second data weight, wherein the real time data processing configuration comprises the first data processing function, the second data processing function, the at least one first data weight and the at least one second data weight.

14. The data processing method of claim 13, wherein the data processing server further comprises a data integrating module, and the data processing method further comprises the following after the step (b1):
(b2) the non-real time data processing module analyzing the data stream according to the first data processing function, the second data processing function, the at least one first data weight and the at least one second data weight to generate a non-real time data output;
wherein the data processing method further comprises the following after the step (g):
(h) the data integrating module retrieving the real time data output and the non-real time data output; and
(i) the data integrating module deciding an integrated data output according to the real time data output and the non-real time data output.
